(19) United States
(12) Patent Application Publication
(10) Pub. No.: US 2004/0213732 A1
(43) Pub. Date: Oct. 28, 2004

(54) Reforming vapor obtained from a biomass

(76) Inventor: Gene E. Lightner, Federal Way, WA (US)

Correspondence Address: Gene E. Lightner, 706 SW 296th St., Federal Way, WA, 98023, US

(21) Appl. No.: 10/067,024

(22) Filed: Feb. 4, 2002

(51) Int. Cl. C01B 3/02

(52) U.S. Cl. 423/648.1

(57) ABSTRACT

Providing a gas containing water vapor and organic vapors, derived from a biomass, is the method presented. The gas, containing water vapor and organic vapors is subjected to a reformer catalyst to react and become a gas containing water vapor, hydrogen and carbon monoxide. Upon subjecting the heretofore reformed gas to a steam shift catalyst, carbon monoxide and water vapor contained within the gas, reacts and forms a gas containing hydrogen and carbon dioxide substantially devoid of carbon monoxide. Providing a solution for substantially removing carbon dioxide from the gas containing hydrogen and mingling the previously obtained gas, containing carbon dioxide and hydrogen with the solution, forms a solution containing a bicarbonate derived from carbon dioxide contained within the gas. Upon separation of the gas, containing hydrogen, from the solution containing a bicarbonate results in a gas containing hydrogen and a solution containing a bicarbonate. Subjecting the bicarbonate containing solution to heat, forms gaseous carbon dioxide and a solution for recycle. Accordingly the method is concluded thereby producing a gas derived from a biomass containing hydrogen substantially devoid of carbon monoxide.

### BACKGROUND OF THE INVENTION

Present day motor vehicles employ internal combustion engines operating with petroleum based liquid fuels. In the future internal combustion engines will, in all likelihood, be replaced with other power sources such as hydrogen based fuel cells. Gasification of biomass is the subject of U.S. Pat. No. 6,048,373, wherein biomass is conveyed to a bed for gasifying biomass to form a gas containing methane, carbon oxides, hydrogen and a biomass residue. The biomass residue contained within the lower portion of the bed is subjected to combustion to produce heat to maintain the bed temperature. A state of the art method for forming hydrogen employs a reformer and is disclosed in U.S. Pat. No. 5,938,800 for transforming organic vapor to form hydrogen. Gas from the reformer commonly contains toxic carbon monoxide which is converted to non-toxic carbon dioxide. Several state of the art methods, employing a catalyst for steam shifting carbon monoxide to form hydrogen, are described in U.S. Pat. Nos. 5,021,233, 4,980,145 and 4,721,611. A state of the art method is divulged in U.S. Pat. No. 6,312,655, for removing carbon dioxide from a gas containing hydrogen to employ a solution to form a bicarbonate. The solution containing the bicarbonate is subjected to heat to release gaseous carbon dioxide and form a regenerated solution for recycle.

The problem with hydrogen powered vehicles is apparently the lack of a low cost practical mobile supply of hydrogen and insufficient range of distance. This problem is solved by the present invention providing hydrogen used to supply power to a fuel cell located in a vehicle.

It is therefore an object of this invention to include many of the features of the prior art and exclude some features of the prior art.

A distinct object of this invention is to react carbon monoxide with water vapor contained in a gas derived from a biomass employing a catalyst to establish a substantial reduction of carbon monoxide to form hydrogen and carbon dioxide from the gas.

Still another object of this invention is to remove carbon dioxide from a gas containing hydrogen to form a bicarbonate solution and separate the bicarbonate solution from the gas.

Yet another object of this invention is to remove gaseous carbon dioxide from the bicarbonate containing solution to release gaseous carbon dioxide and provide recycle of the solution.

With the above and other objects in view, this invention relates to the novel features and alternatives and combinations presently described in the brief description of the invention.

### APPLICATIONS AND BACKGROUND OF THE INVENTION

A supply of gas containing organic vapor, carbon monoxide and carbon dioxide is obtained from pyrolysis of a biomass, hardwood for example, as described within Chemical Process Industries, second edition, authored by R. N. Shreve, pages 702-704.

A steam-hydrocarbon process for reforming, described by Shreve op. cit., within page 135 will transform the organic vapors to a gas containing hydrogen, carbon monoxide and carbon dioxide. The organic vapors are often selected from the group consisting of hydrocarbons, methanol and acetic acid including an individual or combination thereof.

Shifting a gas obtained from the reformer containing water vapor, hydrogen and carbon monoxide is customarily achieved with water vapor or steam to shift carbon monoxide to carbon dioxide. Steam is often reacted with carbon monoxide to shift carbon monoxide, reversibly, to carbon dioxide and hydrogen, described by Shreve op. cit., within page 136.

The gas, substantially free of carbon monoxide, likely contains carbon dioxide and can be scrubbed to remove carbon dioxide. One example of scrubbing a gas containing carbon dioxide is described by Shreve op. cit., within pages 126 and 128 in which sodium carbonate is employed as a solution for scrubbing a flue gas containing carbon dioxide to form sodium bicarbonate ions. The solution containing sodium bicarbonate is then heated to produce concentrated carbon gaseous dioxide and a solution containing sodium carbonate to be recycled.

Shreve, op. cit., pages 131 and 132, describes a method to absorb carbon dioxide in an aqueous solution of monoethanolamine, to provide a solution, in which the absorbed carbon dioxide is removed from the aqueous solution to produce gaseous carbon dioxide. The solution is often selected from the group consisting of aqueous bases and aqueous salts including an individual or a combination of these.

Scrubbing water vapor from a gas is often achieved by a solid absorbent. An absorbent for scrubbing may be selected from the group consisting of silica gel and alumina including an individual or a combination of these absorbents.

Biomass is usually selected from the group consisting of woody material, waste paper and MSW, (municipal solid waste) or may be a liquefied organic mass. The reformer catalyst is usually arranged in series with the steam shift catalyst. The method is often confined to a vehicle and achieved in a continuous mode.

### BRIEF DESCRIPTION OF THE INVENTION

The present invention in its broadest aspect, provides a method to form hydrogen from a gas, derived from pyrolysis of a biomass, containing carbon monoxide, water vapor and organic vapors. The gas is subjected to a reformer catalyst to react with organic vapors to form a gas containing hydrogen and carbon monoxide. Carbon monoxide, within the gas, is reacted with water vapor in the presence of a steam shifting catalyst to convert carbon monoxide to carbon dioxide and hydrogen. A solution is used to remove carbon monoxide from the gas and form a bicarbonate within the solution. The solution containing a bicarbonate, and upon separation from the gas, is subjected to heat to produce gaseous carbon dioxide and a solution for recycling. After separating the gas containing hydrogen, substantially devoid of carbon monoxide and carbon dioxide, the gas is subjected to an absorbent for scrubbing a gas as a means for purification and removal of impurities from the previously separated gas. The purified gas containing hydrogen is substantially devoid of carbon monoxide, water vapor and carbon dioxide will produce hydrogen without employing a membrane. Hydrogen thus produced is regularly employed to power a fuel cell located in a vehicle to produce electrical power for the vehicle.

Characteristics of the invention include;

A biomass upon pyrolysis, without air, produces a gas of organic vapors, hydrogen and carbon monoxide.

Conversion of organic vapors to hydrogen and carbon monoxide utilizing a reformer.

Reacting char from pyrolysis of the biomass with water vapor to produce gaseous hydrogen and carbon monoxide combined within the previously formed gas.

Shifting water vapor and carbon monoxide to carbon dioxide and hydrogen utilizing water vapor contained in the gas.

Providing a solution to form a bicarbonate from carbon dioxide within the gas.

Separating the bicarbonate solution from the gas and heating the bicarbonate solution to produce gaseous carbon dioxide and a solution for recycle.

Separation of carbon gases from hydrogen to produce hydrogen substantially devoid of carbon gases to produce hydrogen to power a fuel cell.

Providing a hydrogen powered fuel cell located in a vehicle.

Storing electric power from the fuel cell within a storage battery.

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting a method to free carbon dioxide from a bicarbonate.

FIG. 3 is a flow sheet denoting a method to convert char from pyrolysis of a biomass to carbon monoxide.

FIG. 4 is a flow sheet denoting a method to store direct current from a fuel cell within a storage battery.

FIG. 5 is a flow sheet denoting a method using an absorbent to provide purified hydrogen.

### DETAILED DESCRIPTION OF THE PREFERRED EMBODIMENT

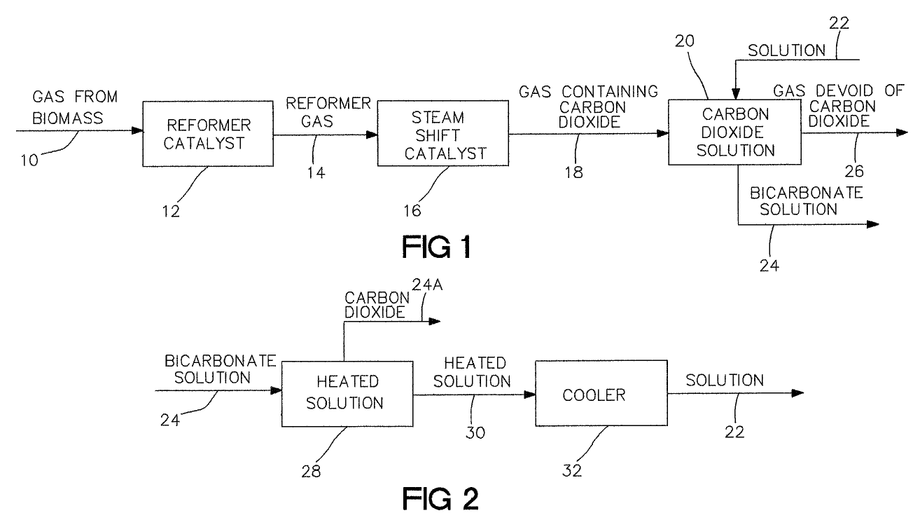

The flow diagram of FIG. 1 illustrates the general preferred embodiment of the present invention. In the diagram, rectangles represent stages, operations or functions of the present invention and not necessarily separate components. Details within each stage, operations or functions are not shown. Lines and arrows indicate direction of flow in the method.

Referring to FIG. 1, a gas from biomass 10 is furnished to a reformer catalyst stage 12 to form a reformer gas 14 containing hydrogen and carbon monoxide. The reformer gas is provided to a steam shift catalyst stage 16 from a supply of water vapor within the gas to form a gas containing hydrogen and carbon monoxide 18. The gas 18 is commingled within a carbon dioxide solution stage 20 with a solution 22 to remove carbon dioxide from gas containing hydrogen and carbon monoxide 18 and form a bicarbonate solution 24 to provide a gas 26, substantially devoid of carbon dioxide but containing hydrogen. The gas from biomass 10 is obtained by pyrolysis of a biomass.

The gas from biomass 10 commonly contains organic vapors and is reformed to form hydrogen. The catalysts requiring heat, is generally heat provided by electricity. The solution 22 to remove carbon dioxide to form a bicarbonate customarily contains a carbonate.

Referring to FIG. 2, a bicarbonate solution 24 is conveyed to heated solution stage 28 to release gaseous carbon dioxide 24A and form a heated solution 30 transferred to cooler stage 32 to form cooled solution 22. Cooled solution 22 is regularly recycled to form additional solution 22. Gaseous carbon dioxide 24A, released from heated solution stage 28, is frequently released to the atmosphere.

Referring to FIG. 3, biomass 10A is conveyed to biomass pyrolysis stage 34 to release gas from biomass 10 and form char 36, a carbonaceous residue. Char 36 is conveyed and pressurized within pressurized glowing char stage 38 to react with water 34A and form gaseous carbon monoxide 40. This reaction regularly takes place in biomass pyrolysis stage 34. Char 36, or carbonaceous residue, is usually referred to as charcoal. The char 36, and water is pressurized to from about 200 psi to about 500 psi. Upon heating to glowing, the carbonaceous residue reacts with water to form carbon monoxide.

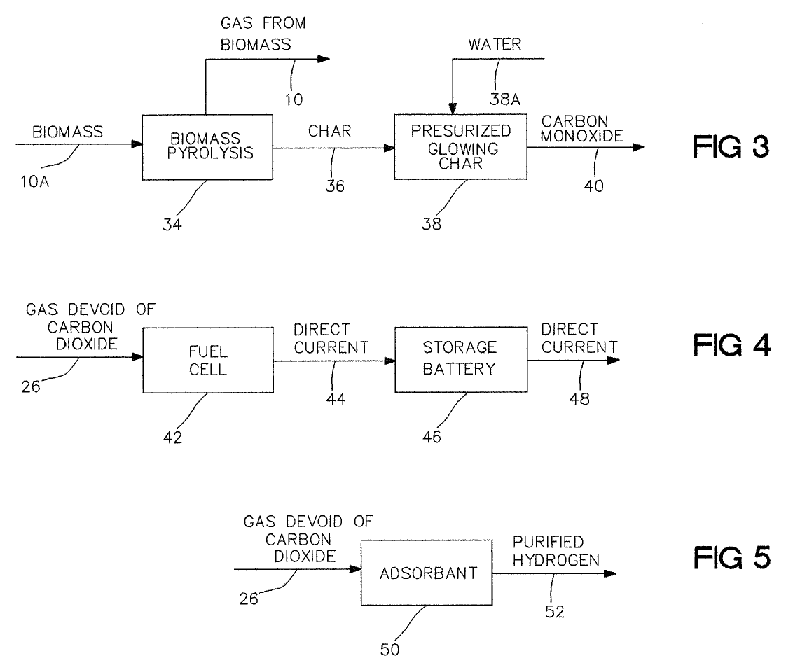

Referring to FIG. 4, gas substantially devoid of carbon dioxide but containing hydrogen 26 is conveyed to a fuel cell 42 which generates electricity to produce direct current 44 which is applied to a storage battery 46 to supply direct current 48. Storage battery 46 releases direct current 48 on demand. Direct current 44 from fuel cell 42 is often applied to power a vehicle and also recharges storage battery 46 within the vehicle.

Referring to FIG. 5, gas, substantially devoid of carbon dioxide but containing hydrogen, 26 is conveyed to absorbent 50 to absorb impurities, such as water vapor, from the gas to supply purified hydrogen 52. Purified hydrogen 52, is customarily utilized to power a fuel cell. Absorbent 50 is heated to release water and other impurities. The heated absorbent is cooled and returned to service as absorbent 50.

What is claimed is:

1. A method to form hydrogen from a gas, derived from a biomass, containing water vapor and organic vapors, and subjecting the gas to a reformer catalyst to become a gas containing hydrogen and carbon monoxide, which comprises:
providing said gas containing organic vapors, and
providing said reformer catalyst, and
subjecting said gas containing water vapor and organic vapors to said reformer catalyst, forming a gas containing water vapor, hydrogen and carbon monoxide, and
providing a steam shift catalyst, and
subjecting the heretofore formed gas containing water vapor, hydrogen and carbon monoxide to said steam shift catalyst, and
reacting carbon monoxide and water vapor within said gas by said steam shift catalyst to shift carbon monoxide to form a gas containing hydrogen and carbon dioxide, and
providing a solution for substantially removing carbon dioxide from the gas containing hydrogen, and
mingling the heretofore reacted gas, substantially devoid of carbon monoxide, containing carbon dioxide and hydrogen, with said solution to form a solution containing a bicarbonate, and
separating the gas, containing hydrogen, from the solution containing a bicarbonate from the carbon dioxide, and
subjecting the solution containing a bicarbonate to heat to form gaseous carbon dioxide and a solution for recycle thereby producing a gas containing hydrogen substantially devoid of carbon monoxide derived from a biomass.

2. The method of claim 1 wherein said gas containing organic vapors is derived from pyrolysis of said biomass.

3. The method of claim 2 wherein the pyrolysis of said biomass is achieved by electrical heat.

4. The method of claim 2 wherein the pyrolysis of said biomass is achieved within a vehicle.

5. The method of claim 2 wherein the pyrolysis of said biomass forms a carbonaceous residue.

6. The method of claim 2 wherein the carbonaceous residue reacts with water to form carbon monoxide

7. The method of claim 6 wherein the carbonaceous residue and water is pressurized to about 200 psi to about 500 psi.

8. The method of claim 1 wherein said biomass is selected from the group consisting of woody material, waste paper and MSW including an individual or combination thereof.

9. The method of claim 1 wherein said solution for removing carbon dioxide is selected from the group consisting of aqueous bases and aqueous salts including an individual or combination thereof.

10. The method of claim 1 wherein hydrogen containing water vapor, substantially devoid of carbon monoxide is subjected to scrubbing within an absorbent for scrubbing water vapor within gaseous hydrogen to furnish a gas, substantially devoid of water vapor, containing hydrogen separated from the absorbent.

11. The method of claim 10 wherein the absorbent, containing water, is subjected to heat forming water vapor and an absorbent for recycle.

12. The method of claim 10 wherein the absorbent for scrubbing is selected from the group consisting of silica gel and alumina including an individual or combination thereof.

13. The method of claim 10 wherein the gas containing hydrogen substantially devoid of impurities is employed to power a fuel cell.

14. The method of claim 13 wherein the fuel cell generates electricity and is subjected to storage within a storage battery.

15. The method of claim 13 wherein the fuel cell is located within a vehicle.

16. The method of claim 1 wherein the method is confined within a vehicle.

17. The method of claim 1 wherein the organic vapor is selected from the group consisting of hydrocarbons, methanol and acetic acid including an individual or combination thereof.

18. The method of claim 1 wherein said reformer catalyst is arranged in series with said steam shift catalyst.

19. The method of claim 1 of said biomass is a liquefied organic mass.

20. The method of claim 1 of said method is achieved in a continuous mode.
